(19) United States
(12) Patent Application Publication
(10) Pub. No.: US 2006/0030484 A1
(43) Pub. Date: Feb. 9, 2006

(54) Multicolor recording medium, multicolor recording method and device using the same

(75) Inventors: Jae-Hwan Kim, Suwon-si (KR); Seung-Min Ryu, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/197,265

(22) Filed: Aug. 5, 2005

(30) Foreign Application Priority Data
Aug. 6, 2004 (KR) 10-2004-0062174

(51) Int. Cl. B41M 5/40

(52) U.S. Cl. 503/204

(57) ABSTRACT

A multicolor recording medium, recording method and device using the same are disclosed. The multicolor recording medium includes a substrate having top and bottom surfaces and a photosensitive decoloring layer. A low-temperature thermosensitive coloring layer is disposed on the top surface of the substrate. A high-temperature thermosensitive coloring layer is disposed on the low-temperature thermosensitive coloring layer.

### CROSS-REFERENCE TO RELATED APPLICATION

This application claims the benefit of Korean Patent Application No. 2004-62174, filed on Aug. 6, 2004, the disclosure of which is incorporated herein by reference in its entirety.

### BACKGROUND OF THE INVENTION

1. Field of the Invention

The present invention relates to a multicolor recording medium and, more particularly, to a multicolor recording medium having at least one coloring layer, and a multicolor recording method and device using the same.

2. Description of the Related Art

Multicolor recording methods are advantageous because, as opposed to a film photograph, a user may collect, edit and output a desired image. The multicolor recording methods may be divided into various types such as a sublimating type using a sublimate-type thermal transfer film, a laser beam printing type using a color toner, a color inkjet type using an ink cartridge, and so forth. However, these techniques have a drawback in that disposable items, such as film, toner, ink etc., used in connection with the recording medium and the recording device must be periodically replaced.

On the other hand, a multicolor recording medium provided with a coloring layer is noteworthy because the multicolor recording medium makes it possible to semi-permanently make use of the recording device without replacing the disposable items.

Japanese Patent Publication No. S59 (1984)-194886 discloses a two-color thermosensitive recording method using a recording medium which is provided with low- and high-temperature thermosensitive coloring layers, wherein the low temperature thermosensitive coloring layer forms colors at a low-temperature and is deposited on a support, and the high-temperature thermosensitive coloring layer forms colors at a high temperature and is deposited on the low-temperature thermosensitive coloring layer. This recording method makes it possible to obtain mixed colors by coloring the low- and high-temperature thermosensitive coloring layers at a certain ratio, but it is not possible to obtain unmixed colors because two colors are mixed.

U.S. Pat. No. 6,297,840 discloses a recording paper and apparatus having thermosensitive coloring layers which consist of yellow, magenta and cyan colors respectively, and which are different in thermosensitivity. This recording apparatus employs a method comprising: developing the first and second colors, irradiating ultraviolet rays to each of the developed colors, and fixing the developed colors. Thereby, it is possible to prevent the developed coloring layers from being developed again when the second and third coloring layers are developed. However, the recording apparatus requires a thermal head having at least three heat energy regions, and two ultraviolet light sources having different maximum wavelength bands. For this reason, the recording apparatus is complicated.

Meanwhile, U.S. Pat. No. 5,667,949 discloses recording paper having thermosensitive coloring layers which consist of yellow, magenta and cyan colors, respectively. Each thermosensitive coloring layer includes an infrared absorbent material for transforming infrared energy into heat energy. Thus, a device using this recording paper requires three infrared laser light sources having different wavelength bands. For the same reason, this device is also complicated.

### SUMMARY OF THE INVENTION

Accordingly, it is an aspect of the present invention to provide a multicolor recording medium capable of being used for a relatively simple recording device without requiring disposable items other than the recording medium and realizing a full color image, and multicolor recording method and device using the same.

Additional aspects and advantages of the present invention will be set forth in part in the description which follows and, in part, will be apparent from the description, or may be learned by practice of the invention.

The foregoing and/or other aspects and advantages of the present invention are achieved by providing a multicolor recording medium. The multicolor recording medium includes a substrate having top and bottom surfaces and a photosensitive decoloring layer. A low-temperature thermosensitive coloring layer is disposed on the top surface of the substrate. A high-temperature thermosensitive coloring layer is disposed on the low-temperature thermosensitive coloring layer. The multicolor recording medium is capable of realizing a full color image using a relatively simple recording device having a single thermal head and a single light source.

According to an aspect of the present invention, the photosensitive decoloring layer is interposed between the low-temperature thermosensitive coloring layer and the high-temperature thermosensitive coloring layer in order to facilitate thermal separation between the photosensitive decoloring layer and the low- and high-temperature thermosensitive coloring layers.

According to another aspect of the present invention, the photosensitive decoloring layer may be disposed on the bottom surface of the substrate, thus being capable of improving durability and gas resistant capability. In this case, in order to facilitate thermal separation between the low- and high-temperature thermosensitive coloring layers, an intermediate layer is interposed between the low-temperature thermosensitive coloring layer and the high-temperature thermosensitive coloring layer.

The foregoing and/or other aspects and advantages of the present invention are also achieved by providing a multicolor recording device. The multicolor recording device includes a light source to apply light to the foregoing recording medium to thus decolor a photosensitive decoloring layer. Further, the multicolor recording device includes a thermal head having high- and low-temperature modes and transmitting heat to the recording medium to color thermosensitive coloring layers of the recording medium. This multicolor recording medium has a relatively simple configuration. The thermal head operates in the high-temperature mode for a short time and in the low-temperature mode for a long time.

The foregoing and/or other aspects and advantages of the present invention are also achieved by providing a multicolor recording method. The multicolor recording method includes feeding the foregoing recording medium, and applying light to the recording medium to thus decolor a photosensitive decoloring layer. High and low heat is transmitted to the recording medium having the decolored photosensitive decoloring layer, thus coloring thermosensitive coloring layers. The high heat is transmitted for a short time and the low heat is transmitted for a long time.

### BRIEF DESCRIPTION OF THE DRAWINGS

The above and/or other features and advantages of the present general inventive concept will become more apparent to those of ordinary skill in the art by describing in detail preferred embodiments thereof with reference to the attached drawings of which:

FIG. 1 is a cross-sectional view showing a multicolor recording medium and fabricating method according to a first embodiment of the present invention;

FIG. 2 is a cross-sectional view showing a multicolor recording medium and fabricating method according to a second embodiment of the present invention; and

FIG. 3 is a schematic cross-sectional view showing a multicolor recording device and method using a multicolor recording medium according to a third embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

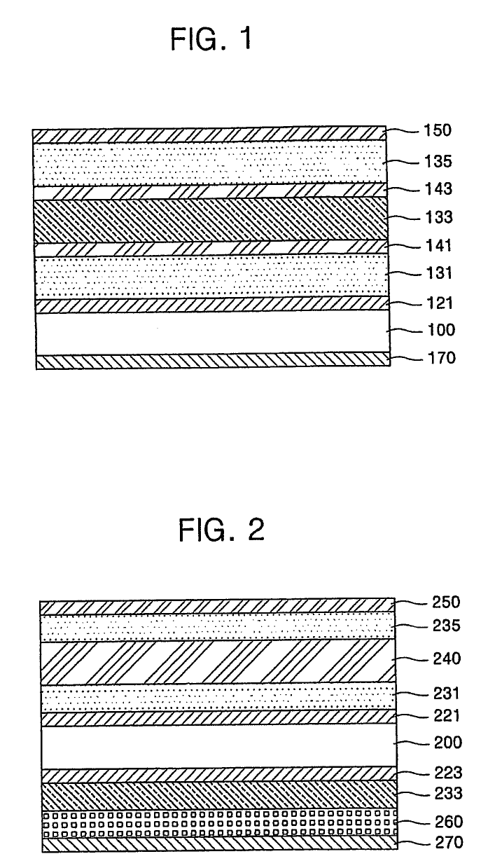

FIG. 1 is a cross-sectional view showing a multicolor recording medium according to a first embodiment of the present invention.

Referring to FIG. 1, the multicolor recording medium according to the first embodiment comprises a substrate 100 having top and bottom surfaces. The substrate 100 may be paper, film, composite paper of paper and film, synthetic paper, or photographic paper (so-called “baryta paper” or other media that may record information). More particularly, the paper may be wood-free printing paper, computer paper, vellum paper, single- or double-sided art paper, cast coating paper, or so forth. The film may be a polyester film, a polycarbonate film, a cellulose-acetate film, or a polyethylene film. In this case, the selected film may be a transparent, semitransparent or opaque plastic films. The composite paper may be coated with polyethylene, polypropylene or so forth throughout the single- or double-sided surface. The substrate 100 may have a thickness between about 15 μm and about 350 μm to facilitate treatment as well as prevent deflection when at least one coating layer is formed on the top surface thereof.

A low-temperature thermosensitive coloring layer 131 is located over the top surface of the substrate 100, and a high-temperature thermosensitive coloring layer 135 is located over the low-temperature thermosensitive coloring layer 131. Herein, the thermosensitive coloring layer refers to a layer forming colors when being exposed to heat. Specifically, the low-temperature thermosensitive coloring layer 131 is a layer in which a minimum temperature required to form colors is low, while the high-temperature thermosensitive coloring layer 135 is a layer in which a minimum temperature required to form colors is high. Here, the terms “low temperature” and “high temperature” are meant as relative numerical values rather than absolute specific values.

In this manner, the low- and high-temperature thermosensitive coloring layers 131 and 135 are sequentially deposited on the substrate 100, thereby coloring each of the thermosensitive coloring layers 131 and 135 by use of a single thermal head having low- and high-temperature modes. The thermal head serves as means for transmitting heat to a recording medium when an image is displayed on the recording medium, and is located over the recording medium, i.e., the high-temperature thermosensitive coloring layer 135. Furthermore, for the thermal head, for example, a time of coming into contact with the recording medium is kept short in the high-temperature mode, but relatively long in the low-temperature mode.

In the high temperature mode, the high-temperature thermosensitive coloring layer 135 adjacent to the thermal head may be colored by high temperature, but the low-temperature thermosensitive coloring layer 131 remote from the thermal head may not be colored by a short contact time and the resulting insufficient heat transmission. Further, in the low temperature mode, the high-temperature thermosensitive coloring layer 135 may not be colored by low temperature, but the low-temperature thermosensitive coloring layer 131 may be colored by a long operation time and the resulting sufficient heat transmission.

A photosensitive decoloring layer 133 is interposed between the low-temperature thermosensitive coloring layer 131 and the high-temperature thermosensitive coloring layer 135. The photosensitive decoloring layer 133 is a layer which has already offered a certain color and is decolored when being exposed to light. The thermosensitive coloring layers 131 and 135 and the photosensitive decoloring layer 133 may display yellow, magenta and cyan colors respectively, regardless of their sequences. Accordingly, the recording medium according to the first embodiment is capable of realizing a full color image by combination of the colors on which the thermosensitive coloring layers 131 and 135 and the photosensitive decoloring layer 133 display. Furthermore, the recording medium according to the first embodiment is capable of realizing the full color image by a relatively simple recording device, wherein the relatively simple recording device is provided with the single thermal head having both the high temperature mode and the low temperature mode together and a single light source.

Since being interposed between the low-temperature thermosensitive coloring layer 131 and the high-temperature thermosensitive coloring layer 135, the photosensitive decoloring layer 133 facilitates thermal separation between the high-temperature thermosensitive coloring layer 135 and the low-temperature thermosensitive coloring layer 131 to prevent the low-temperature thermosensitive coloring layer 131 from being colored arbitrarily when the thermal head operates at a high temperature for a short time. However, there is no limitation to a position of the photosensitive decoloring layer 133. For instance, when the photosensitive decoloring layer 133 is deposited at a different position, an intermediate layer may be disposed between the low- and high-temperature thermosensitive coloring layers 131 and 135 in order to facilitate the thermal separation between the thermosensitive coloring layers.

The thermosensitive coloring layers may include a coloring material which is directly or indirectly colored by heat transmitted from the thermal head. The coloring material directly colored by the heat may include one which is transformed in structure at a particular temperature, which is changed in crystallinity, or which is colored during separation of a leaving group. Further, the coloring material indirectly colored by the heat may include a mixture of a developer and a color precursor, or a mixture of a microcapsule having the developer or coupler and a color precursor. Here, the developer refers to a material which is activated at a specific temperature to produce acids etc., and the color precursor refers to a material which reacts with the produced acids to thereby be colored. Further, the microcapsule is formed of a material where transmittance of the developer, the coupler or the color precursor is changed at a specific temperature. The color precursor may include a leuco dye. Moreover, the leuco dye may include any one selected from a lactone leuco dye, a phenothiazine leuco dye, and a triarylpyridine leuco dye. Further, the developer may be an organic acid material.

The photosensitive decoloring layer may include a material which is directly or indirectly decolored by light emitted from a light source. The material directly decolored by the light may include one which is changed in structure at a specific wavelength, which is changed in crystallinity, which can be self-coupled or which is decolored during separation of a leaving group. Further, the material indirectly decolored by the light may include a mixture of a decolorant and a pigment, a mixture of a light-heat conversion agent and a thermal-sensitive decolorant, or a mixture of a microcapsule containing the decolorant and the pigment. The decolorant is activated at a specific wavelength to thereby produce a light-free radical, for example, composed of a radical, an ion and so forth, and the colorant reacts with the light-free radical to thereby be decolored.

The material that is directly or indirectly decolored by the light may be any material which is converted into a material that is decolored by the light, namely, that does not substantially absorb light belonging to a visible light region. For example, the material may be an azo pigment, an azomethine pigment, a polymethine pigment, a quinone pigment, an indigo pigment, a diphenylmethane pigment, a tripethylmethane pigment, a phthalocyanine pigment, and so forth. Among them, the azomethine pigment may be used in view of a color tone, photosensitive decoloring characteristics, stability, costs and so on. Examples of the azomethine pigment are expressed by, but not limited to, the following Formulas 1 to 11.

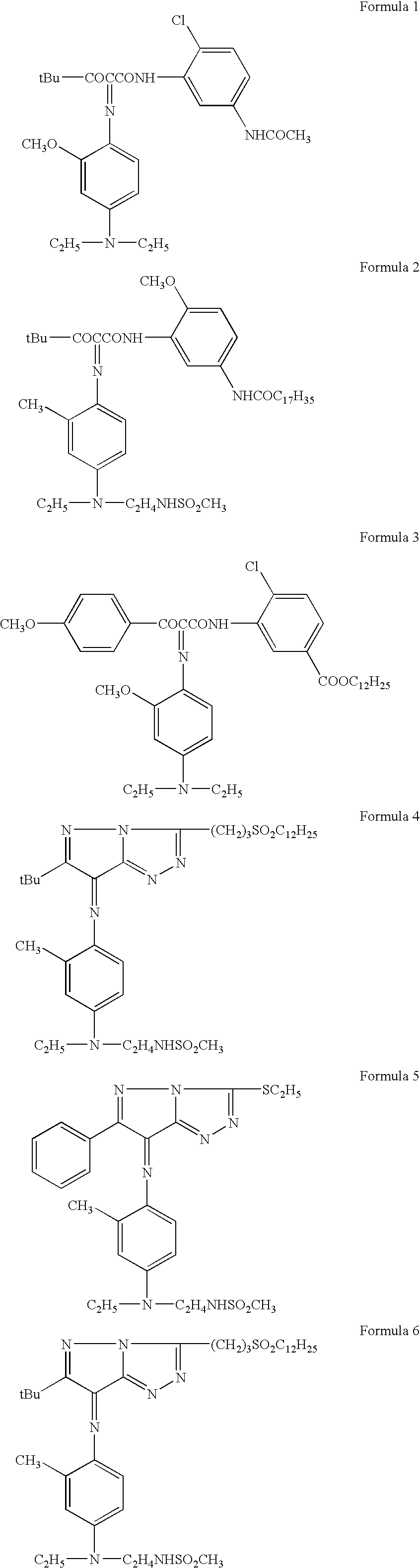

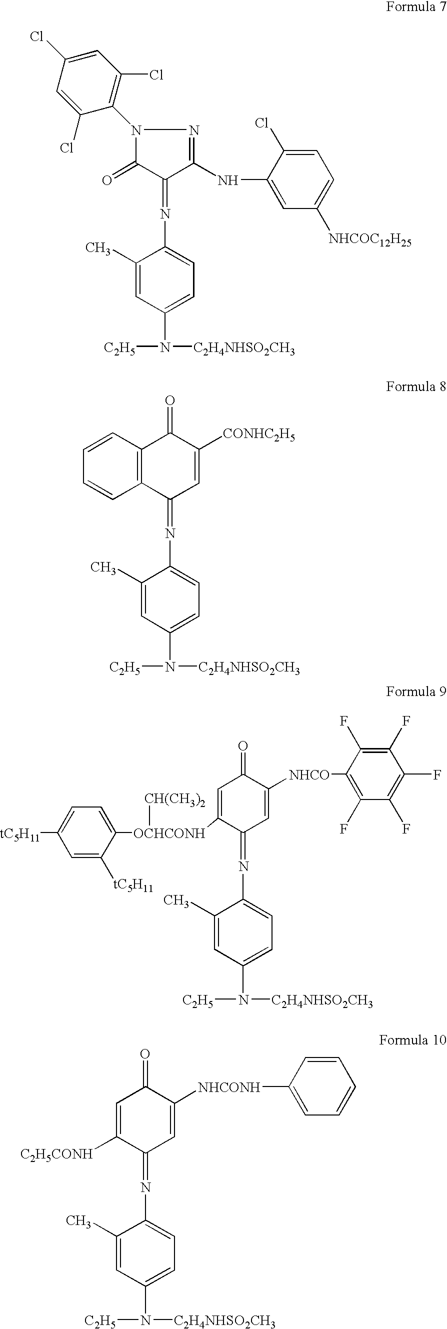

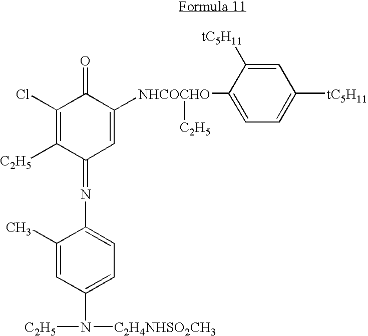

The decolorant may be any material that absorbs a specific wavelength of light, thereby being capable of being activated to decolor the pigment. A wavelength of the light activating the decolorant may be selected in view of characteristics handled as a recording material, availability of the light to be used, costs and so on. For example, the light activating the decolorant may be either part ultraviolet light region and visible light region, or an infrared light region. The decolorant may include a carbonyl compound such as anthraquinone etc., a phosphorus compound such as acyl phosphine oxide etc., a diazo compound and so on. Among these materials, from a viewpoint of activation efficiency, i.e. production efficiency of a light-free radical, the material having a spectral absorption wavelength between about 250 nm and about 450 nm may be used. These decolorants are exemplified by, but not limited to, the following Formulas 12 to 38.

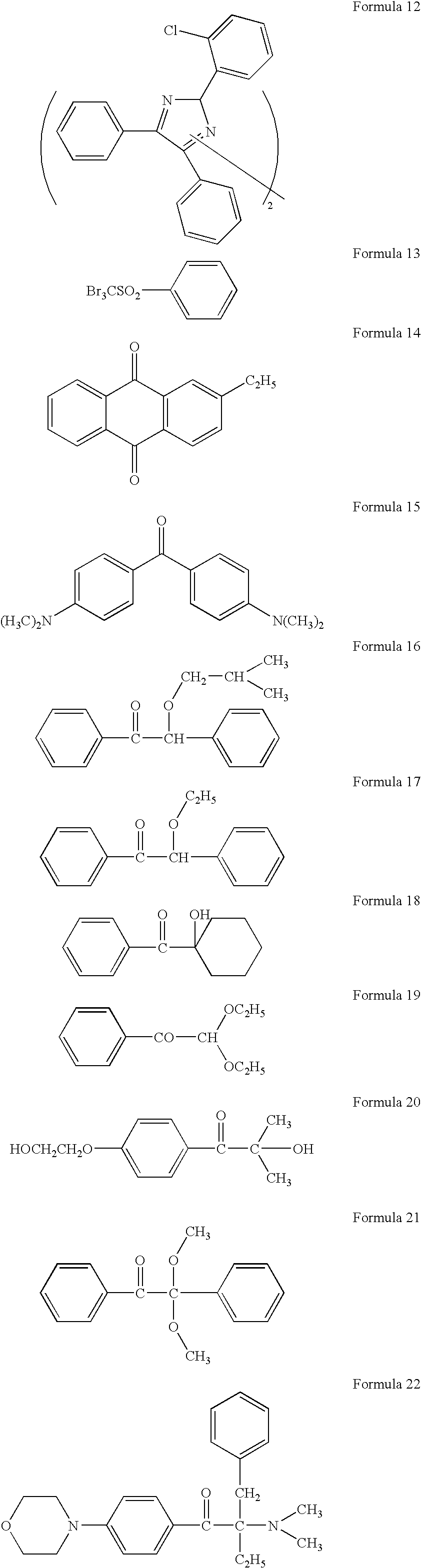

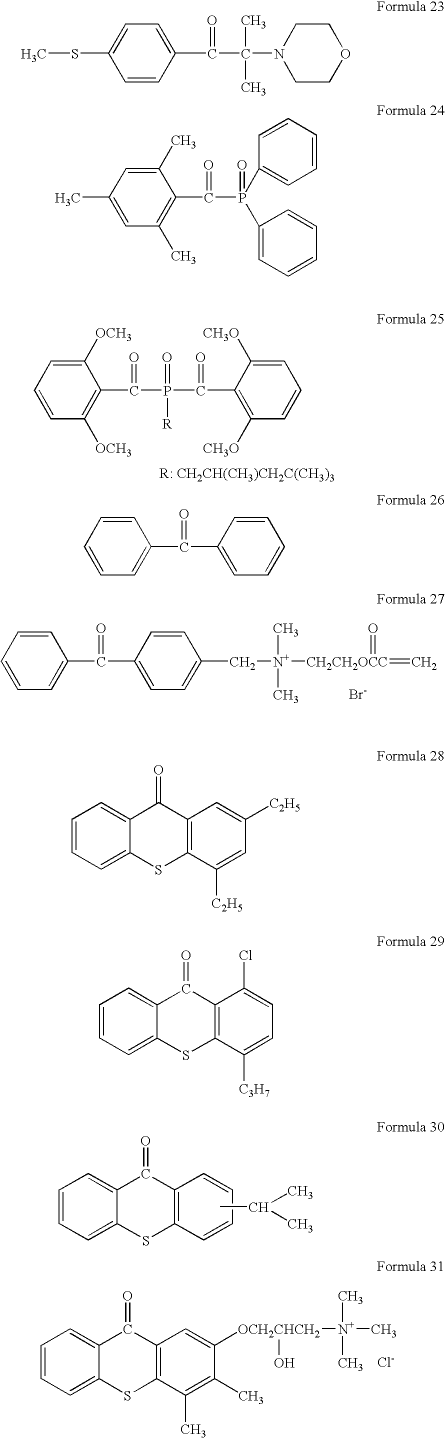

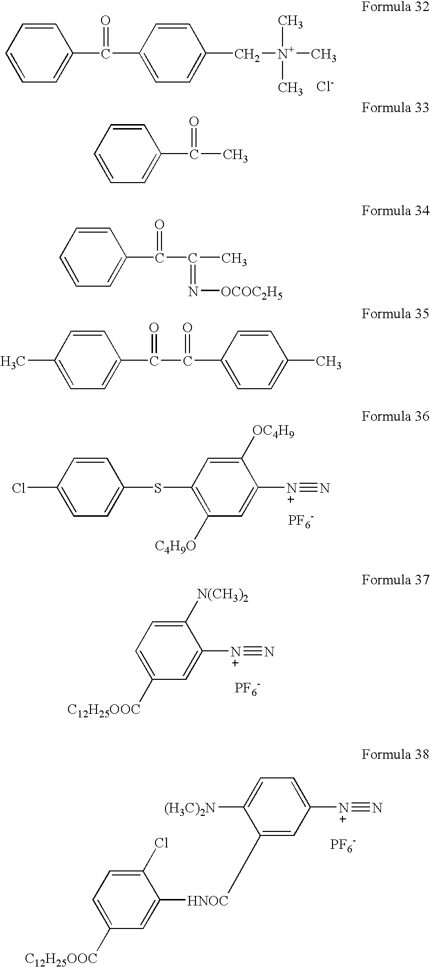

A resin forming the thermosensitive coloring layers and the photosensitive decoloring layer may be further provided. For example, the resin may include gelatin, polyvinyl chloride, polystyrene, polyester, polyurethane, polycarbonate, polyacrylate or polyvinyl alcohol.

A first intermediate layer 141 may be interposed between the low-temperature thermosensitive coloring layer 131 and the photosensitive decoloring layer 133, and a second intermediate layer 143 may be interposed between the photosensitive decoloring layer 133 and the high-temperature thermosensitive coloring layer 135. Alternatively, any one of the first and second intermediate layers 141 and 143 may be omitted. When colors are formed from the thermosensitive coloring layer adjacent to the first and second intermediate layers 141 and 143, the first and second intermediate layers 141 and 143 can prevent the formed colors from being spread. Further, the first and second intermediate layers 141 and 143 can prevent the light free radicals etc., which are produced by illumination of the light into the respective adjacent photosensitive decoloring layer, from being diffused to other layers to decolor. In addition, when the respective adjacent thermosensitive coloring and photosensitive decoloring layers are coated with similar organic solvents, the first and second intermediate layers 141 and 143 serve to prevent damage to the previously formed layers.

An undercoating layer 121 is interposed between the low-temperature thermosensitive coloring layer 131 and the substrate 100. The undercoating layer 121 can improve coating capability with respect to the substrate 100 as well as adhesive strength of the substrate 100 and the low-temperature thermosensitive coloring layer 131 when the low-temperature thermosensitive coloring layer 131 is coated. Further, when the low-temperature thermosensitive coloring layer 131 forms the color, the undercoating layer 121 can prevent the formed color from being spread to the substrate 100. The undercoating layer 121 may have, but is not limited to, a thickness between about 0.5 μm and about 4 μm.

A passivation layer 150 may be deposited on the high-temperature thermosensitive coloring layer 135. The passivation layer 150 comes into direct contact with the thermal head, and has stability to heat. Further, the passivation layer 150 does not only protect both the thermosensitive coloring layers 131 and 135 and the photosensitive decoloring layer 133, but also adjusts a gloss, etc. of a surface of the recording medium. The passivation layer 150 may be formed in a single-layer or multi-layer structure as necessary. For instance, the passivation layer 150 may be formed in the single-layer structure containing an ultraviolet absorbent, etc., in order to prevent variation of color caused by exposure to ultraviolet rays while the recording medium is preserved after an image is recorded on the recording medium. Alternately, an ultraviolet filtering layer may be further deposited on the passivation layer 150. The ultraviolet filtering layer may be formed by a coating method or a laminating method. When the ultraviolet filtering layer is formed by the laminating method, an adhesive layer may be added between the passivation layer and the ultraviolet filtering layer.

A backside coating layer 170 may be deposited on a bottom surface of the substrate 100. The backside coating layer 170 either prevents curling of the recording medium or improves feed capability when being applied to the recording device. However, when the substrate 100 is of the same type as the photographic paper, the substrate 100 may be already provided with the backside coating layer 170.

All of the layers, i.e., the undercoating layer 121, the thermosensitive coloring layers 131 and 135, the photosensitive decoloring layer 133, the intermediate layers 141 and 143, the passivation layer 150 and the backside coating layer 170, may be formed using a method which is generally employed when the recording medium is formed. For instance, the respective layers may be applied, dried and formed by using an air knife coating method, a vari-bar blade coating method, a pure blade coating method, a rod blade coating method, a short dwell coating method, a curtain coating method, a slot die coating method, a gravure coating method or a comma coating method. Alternately, some of the layers may be applied and dried by using a die coating method. The passivation layer 150 and/or the backside coating layer 170 may be formed by a laminating method.

FIG. 2 is a cross-sectional view showing a multicolor recording medium according to a second embodiment of the present invention. The multicolor recording medium according to the second embodiment has a photosensitive decoloring layer below a bottom surface of a substrate, unlike that according to the foregoing first embodiment.

Referring to FIG. 2, the multicolor recording medium according to the second embodiment comprises a substrate 200 having top and bottom surfaces. The substrate 200 is formed of a transparent material, such as a film. The film may include a polyester film, a polycarbonate film, a cellulose-acetate film, or a polyethylene film. The substrate 200 may have, but is not limited to, a thickness between about 15 μm and about 350 μm to facilitate treatment as well as prevent deflection when at least one coating layer is formed on the top surface thereof.

A low-temperature thermosensitive coloring layer 231 is located over the top surface of the substrate 200, and a high-temperature thermosensitive coloring layer 235 is located over the low-temperature thermosensitive coloring layer 231. Therefore, each of the thermosensitive coloring layers 231 and 235 can be colored using a single thermal head having high- and low-temperature modes. Meanwhile, a photosensitive decoloring layer 233 is disposed on the bottom surface of the substrate 200. The thermosensitive coloring layers 231 and 235 and the photosensitive decoloring layer 233 may display yellow, magenta and cyan colors respectively, regardless of their sequences. Accordingly, the recording medium according to the second embodiment is capable of realizing a full color image by combination of the colors on which the thermosensitive coloring layers 231 and 235 and the photosensitive decoloring layer 233 display. Furthermore, the recording medium according to the second embodiment is capable of realizing the full color image by a relatively simple recording device composed of the single thermal head having both the high temperature mode and the low temperature mode together and a single light source.

The photosensitive decoloring layer 233 is disposed over the bottom surface of the substrate 200. If necessary to improve heat resistance, or prevent oxidation by substances, etc. contained in external air, or improve gas resistance (chemical resistance), the photosensitive decoloring layer 233 can be protected by the substrate 200.

As a detailed description of the thermosensitive coloring layers 231 and 235 and the photosensitive decoloring layer 233, the corresponding parts of the foregoing first embodiment will be referred to.

An intermediate layer 240 is interposed between the thermosensitive coloring layers 231 and 235. The intermediate layer 240 facilitates thermal separation between the thermosensitive coloring layers 231 and 235, thus being capable of preventing undesired coloring. To this end, the intermediate layer 240 has a thickness between about 0.5 μm and about 50 μm. Further, when colors are formed from the thermosensitive coloring layers adjacent to the intermediate layer 240, the intermediate layer 240 can prevent the formed colors from being spread to other layers. In addition, when the thermosensitive coloring layers adjacent to the intermediate layer 240 are coated by use of organic solvents similar to each other, the intermediate layer 240 can prevent damage of a previously formed layer.

A first undercoating layer 221 may be interposed between the low-temperature thermosensitive coloring layer 231 and the substrate 200. Further, a second undercoating layer 223 may be interposed between the photosensitive decoloring layer 233 and the substrate 200. The first and second undercoating layers 221 and 223 can improve both coating capability with respect to the substrate 200 and adhesive strength between the substrate 200 and the low-temperature thermosensitive coloring layer 231 or the photosensitive decoloring layer 233 when the low-temperature thermosensitive coloring layer 231 and the photosensitive decoloring layer 233 are coated. Further, when the thermosensitive coloring layers 231 and 235 form the colors, the undercoating layers 221 and 223 can prevent the formed colors from being spread to the substrate 200. To this end, the undercoating layers 221 and 223 may have, but are not limited to, a thickness between about 0.5 μm and about 4 μm.

An opaque reflection layer 260 is deposited on the photosensitive decoloring layer 233. The opaque reflection layer 260 reflects light passing through the substrate 200, thereby making it possible to look at the image recorded on the recording medium only from the top surface of the substrate 200. The opaque reflection layer 260 may contain titanium oxide.

A passivation layer 250 may be deposited on the high-temperature thermosensitive coloring layer 235. A backside coating layer 270 may be deposited on the opaque reflection layer 260. For a detailed description of the passivation layer 250 and the backside coating layer 270, refer to the foregoing first embodiment.

For a detailed method of forming the respective layers on the top and bottom surfaces of the substrate 200, refer to the foregoing first embodiment.

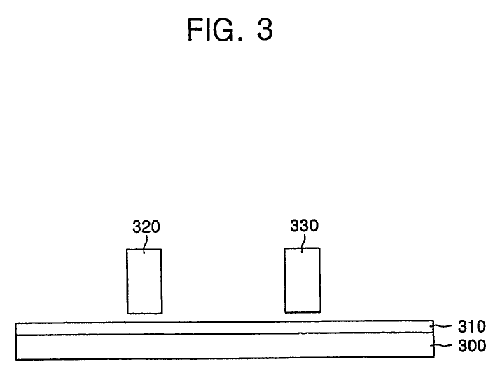

FIG. 3 is a schematic cross-sectional view showing a multicolor recording device for use in connection with the first and second embodiments of the present invention.

Referring to FIG. 3, a thermal head 320 and a light source 330 are disposed over a support 300. The thermal head 320 operates in two modes: high-temperature and low-temperature. The thermal head 320 operates for a short time in the high-temperature mode, but for a long time in the low-temperature mode. Further, the light source 330 may emit a laser beam of a proper wavelength band.

A multicolor recording medium 310 according to the embodiments of the present invention is fed onto the support 300. More particularly, the multicolor recording medium 310 comprises the substrate (100 of FIG. 1 or 200 of FIG. 2), a low-temperature thermosensitive coloring layer (131 of FIG. 1 or 231 of FIG. 2) and a high-temperature thermosensitive coloring layer (135 of FIG. 1 or 235 of FIG. 2) which are sequentially disposed on the top surface of the substrate, and a photosensitive decoloring layer (133 of FIG. 1 or 233 of FIG. 2).

Subsequently, light is applied from the light source 330 to a first region of the multicolor recording medium 310 fed onto the support 300. At this point, a decolorant contained in the photosensitive decoloring layer (133 of FIG. 1 or 233 of FIG. 2) of the multicolor recording medium 310 is subjected to direct or indirect reaction by the light, thus being capable of removing color. Consequently, the photosensitive decoloring layer of the first region is decolored.

Next, the thermal head 320 comes into contact on the first and/or second region of the multicolor recording medium 310, and operates at a high temperature for a short time. At this time, a colorant contained in the high-temperature thermosensitive coloring layer (135 of FIG. 1 or 235 of FIG. 2) reacts to high heat transmitted from the thermal head 320, and thereby a portion coming into contact with the thermal head 320 is colored. However, the low-temperature thermosensitive coloring layer (131 of FIG. 1 or 231 of FIG. 2) is inhibited from being colored because the heat is not sufficiently transmitted from the thermal head 320. Consequently, the high-temperature thermosensitive coloring layer of the first and/or second region is colored.

Then, the thermal head 320 comes into contact on at least one of the first, second and third regions of the multicolor recording medium 310, and operates at a low temperature for a long time. At this time, the high-temperature thermosensitive coloring layer (135 of FIG. 1 or 235 of FIG. 2) is not supplied with the high heat for forming color, thereby being inhibited from being colored. By contrast, the low-temperature thermosensitive coloring layer (131 of FIG. 1 or 231 of FIG. 2) is supplied with the heat from the thermal head 320 for a long time, thus having the heat transmitted sufficiently. Accordingly, a portion coming into contact with the thermal head 320 can be colored. Consequently, the low-temperature thermosensitive coloring layer of at least one of the first, second and third regions is colored. Thereby, it is possible to realize the full color image by means of combination of the colors which the thermosensitive coloring layers and the photosensitive decoloring layer.

As set forth above, applying the light from the light source 330 is performed prior to transmitting the heat from the thermal head 320. Thereby, it is possible to improve efficiency of the light reaching the photosensitive decoloring layer (133 of FIG. 1 or 233 of FIG. 2). Specifically, when the thermosensitive coloring layers are colored before applying the light and then the light is applied, the applied light has to pass through the thermosensitive coloring layers. For this reason, the light reaching the photosensitive decoloring layer may be reduced in efficiency. However, the high- and low-temperature heat transmission processes are not constricted by the foregoing sequences, and thus they may be carried out opposite to the sequences.

Hereinafter, the embodiments of the present invention will be described with reference to the following Examples, which are for illustrative purposes and therefore not limiting.

### FABRICATION EXAMPLE 1

(1) Preparation of a Composition Solution (Composition Solution A) for a Low-Temperature Thermosensitive Coloring Layer

A color precursor dispersion solution having a volume average diameter of 1 micron was prepared by adding 40 weight parts of 3,6-diethoxy fluoran as a color precursor to 160 weight parts of 3.5 wt % polyvinyl alcohol aqueous solution and pulverizing the mixture with a ball mill. Then, a developer dispersion solution having a volume average diameter of 1 micron was prepared by adding 40 weight parts of 1,1-bis(4-hydroxyphenyl)cyclohexane as a developer to 160 weight parts of 3.5 wt % polyvinyl alcohol aqueous solution and pulverizing the mixture with a ball mill. The two kinds of dispersion solutions were mixed and then added by 750 weight parts of styrene butadiene latex (LX415, available from Sumitomo Metal Industries, Ltd. of Japan) as a sensitizer having a solid concentration of 43 wt %. Thereby, a composition solution for a low-temperature thermosensitive coloring layer was prepared, which is capable of forming yellow color by exposure to heat at a low temperature for a long time.

(2) Preparation of a Composition Solution (Composition Solution B) for a High-Temperature Thermosensitive Coloring Layer

A color precursor dispersion solution having a volume average diameter of 1 micron was prepared by adding 40 weight parts of 3,6-bis(diphenylamino)fluoran as a color precursor to 160 weight parts of 3.5 wt % polyvinyl alcohol aqueous solution and pulverizing the mixture with a ball mill. Then, a developer dispersion solution having a volume average diameter of 1 micron was prepared by adding 100 weight parts of 1,1-bis(4-hydroxyphenyl)sulfone as a developer to 400 weight parts of 3.5 wt % polyvinyl alcohol aqueous solution and pulverizing the mixture with a ball mill. The two kinds of dispersion solutions were mixed to prepare a composition solution for a high-temperature thermosensitive coloring layer which is capable of forming cyan color by exposure to heat at a high temperature for a short time.

(3) Preparation of a Composition Solution (Composition Solution C) for a Photosensitive Decoloring Layer

A pigment and decolorant dispersion solution having a volume average diameter of 1 micron was prepared by adding both 10 weight parts of magenta pigment represented by Formula 4 and 20 weight parts of decolorant represented by Formula 24 to 500 weight parts of 3.5 wt % polyvinyl alcohol aqueous solution and pulverizing the mixture with a ball mill. Thereby, a composition solution for a photosensitive decoloring layer was prepared, which has the magenta pigment and is capable of removing magenta color of the magenta pigment by applying light having a specific wavelength region.

(4) Fabrication of a Recording Medium

The composition solutions A, C and B were sequentially applied on a substrate of white polyethylene terephthalate (PET), which was subjected to corona treatment and had a thickness of 100 microns, so that applied amounts of a soluble solid amounted to 4 g/m², 2 g/m², and 4 g/m², respectively. Then, the applied substrate was dried with hot air at a temperature of 60° C. Thereby, a recording medium on which the low-temperature thermosensitive coloring layer, the photosensitive decoloring layer and the high-temperature thermosensitive coloring layer were sequentially deposited on the substrate was prepared.

### FABRICATION EXAMPLE 2

(1) Preparation of a Composition Solution (Composition Solution D) for a Low-Temperature Thermosensitive Coloring Layer

Preparation of a color precursor capsule solution: A color precursor solution was obtained by dissolving 3 weight parts of 3,6-diethoxy fluoran as a color precursor in a mixed solvent having 20 weight parts of ethyl acetate and 20 weight parts of alkyl naphthalene. 15 weight parts of xylene diisocyanate-trimethylolpropane 3:1 adduct as a material of a microcapsule wall, 6 weight parts of hexamethylene diisocyanate-trimethylolpropane 3:1 adduct, and 1 weight part of para-toluene sulfonamide were added to the color precursor solution and uniformly agitated. In addition, 54 weight parts of 8 wt % gelatin aqueous solution was added and emulsified with a homogenizer. The obtained emulsion was homogenized together with 68 weight parts of water, agitated and subjected to encapsulation reaction at 50° C. for 3 hours. Thereby, the color precursor capsule solution having a volume average diameter of 1.5 microns was prepared. At that time, a glass transition temperature of the capsule wall was about 80° C.

Preparation of a developer dispersion solution: 30 weight parts of bisphenol A as a developer was added to 150 weight parts of 8 wt % gelatin aqueous solution, and pulverized with a ball mill. Thereby, the developer dispersion solution having a volume average diameter of 1.2 microns was prepared.

Preparation of a composition solution for a low-temperature thermosensitive coloring layer: The capsule solution and the developer dispersion solution were mixed so that a ratio of the color precursor to the developer was 1:5. Thereby, the composition solution for the low-temperature thermosensitive coloring layer was prepared, which is capable of forming yellow color by exposure to heat at a low temperature for a long time.

(2) Preparation of a Composition Solution (Composition Solution E) for a High-Temperature Thermosensitive Coloring Layer

Preparation of a color precursor capsule solution: A color precursor solution was obtained by adding 3 weight parts of 3-diethylamino-7-chloro fluoran as a color precursor was dissolved in a mixed solvent having 20 weight parts of ethyl acetate and 20 weight parts of alkyl naphthalene. 20 weight parts of xylene diisocyanate-trimethylolpropane 3:1 adduct as a material of a microcapsule wall was added to the color precursor solution and then uniformly agitated. In addition, 54 weight parts of 8 wt % gelatin aqueous solution was added and emulsified with a homogenizer. The obtained emulsion was homogenized together with 68 weight parts of water, agitated and subjected to encapsulation reaction at 50° C. for 3 hours. Thereby, the color precursor capsule solution having a volume average diameter of 1.7 microns was prepared. At that time, a glass transition temperature (Tg) of the capsule wall was about 150° C.

Preparation of a developer dispersion solution: 30 weight parts of bisphenol A as a developer was added to 150 weight parts of 8 wt % gelatin aqueous solution, and pulverized with a ball mill. Thereby, the developer dispersion solution having a volume average diameter of 1.2 microns was prepared.

Preparation of a composition solution for a high-temperature thermosensitive coloring layer: The capsule solution and the developer dispersion solution were mixed so that a ratio of the color precursor to the developer is 1:5. Thereby, the composition solution for the high-temperature thermosensitive coloring layer was prepared, which is capable of forming magenta color by exposure to heat at a high temperature for a short time.

(3) Preparation of a Composition Solution (Composition Solution F) for a Photosensitive Decoloring Layer

A pigment and decolorant dispersion solution having a volume average diameter of 1 micron was prepared by adding both 10 weight parts of cyan pigment represented by Formula 9 and 20 weight parts of decolorant represented by Formula 25 to 500 weight parts of 3.5 wt % polyvinyl alcohol aqueous solution and pulverizing the mixture with a ball mill. Thereby, a composition solution for a photosensitive decoloring layer was prepared, which has the cyan pigment and is capable of removing cyan color of the cyan pigment by applying light having a specific wavelength region.

(4) Fabrication of a Recording Medium

The composition solutions D, F and E were sequentially applied on a substrate of white polyethylene terephthalate (PET), which was subjected to corona treatment and had a thickness of 100 microns, so that applied amounts of a soluble solid amounted to 5 g/m², 2 g/m², and 5 g/m², respectively. Then, the applied substrate was dried with hot air at a temperature of 60° C. Thereby, the recording medium on which the low-temperature thermosensitive coloring layer, the photosensitive decoloring layer and the high-temperature thermosensitive coloring layer were sequentially deposited on the substrate was prepared.

### COMPARATIVE EXAMPLE 1

A recording medium was fabricated in the same method as in Fabrication Example 1, except that the composition solutions A, B and C of Fabrication Example 1 were applied, in the order of the composition solutions C, B and A, on the substrate of polyethylene terephthalate (PET), which was subjected to corona treatment and had the thickness of 100 microns. Therefore, the recording medium on which the photosensitive decoloring layer, the high-temperature thermosensitive coloring layer and the low-temperature thermosensitive coloring layer were sequentially deposited on the substrate was prepared.

### COMPARATIVE EXAMPLE 2

A recording medium was fabricated in the same method as in Fabrication Example 1, except that the composition solutions A, B and C of Fabrication Example 1 were applied, in the order of the composition solutions B, C and A, on the substrate of white polyethylene terephthalate (PET) which was subjected to corona treatment and had the thickness of 100 microns. Therefore, the recording medium on which the high-temperature thermosensitive coloring layer, the photosensitive decoloring layer and the low-temperature thermosensitive coloring layer were sequentially deposited on the substrate was prepared.

### COMPARATIVE EXAMPLE 3

(1) Preparation of a Composition Solution (Composition Solution G) for an Intermediate-Temperature Thermosensitive Coloring Layer

Preparation of a color precursor capsule solution: A color precursor solution was obtained by dissolving 3 weight parts of 3,6-bis(diphenylamino)fluoran as a color precursor in a mixed solvent having 20 weight parts of ethyl acetate and 20 weight parts of alkyl naphthalene. 15 weight parts of xylene diisocyanate-trimethylolpropane 3:1 adduct as a material of a microcapsule wall and 6 weight parts of hexamethylene diisocyanate-trimethylolpropane 3:1 adduct were added to the color precursor solution and uniformly agitated. In addition, 54 weight parts of 8 wt % gelatin aqueous solution was added and emulsified with a homogenizer. The obtained emulsion was homogenized together with 68 weight parts of water, agitated and subjected to encapsulation reaction at 50° C. for 3 hours. Thereby, the color precursor capsule solution having a volume average diameter of 1.6 microns was prepared. At that time, a glass transition temperature (Tg) of the capsule wall was about 120° C.

Preparation of a developer dispersion solution: 30 weight parts of bisphenol A as a developer was added to 150 weight parts of 8 wt % gelatin aqueous solution, and pulverized with a ball mill. Thereby, the developer dispersion solution having a volume average diameter of 1.2 microns was prepared.

Preparation of a composition solution for an intermediate-temperature thermosensitive coloring layer: The capsule solution and the developer dispersion solution were mixed so that a ratio of the color precursor to the developer is 1:5. Thereby, the composition solution for the intermediate-temperature thermosensitive coloring layer was prepared, which is capable of forming cyan color by exposure to heat at an intermediate temperature for an intermediate time.

(2) Fabrication of a Recording Medium

The composition solutions D and E of Fabrication Example 2 and the composition solution G were applied, in the order of the composition solutions D, G and E, on a substrate of white polyethylene terephthalate (PET) which was subjected to corona treatment and had a thickness of 100 microns, so that applied amounts of a soluble solid amounted to 5 g/m², 5 g/m², and 5 g/m², respectively. Then, the applied substrate was dried with hot air at a temperature of 60° C. Thereby, the recording medium on which the low-temperature thermosensitive coloring layer, the intermediate-temperature thermosensitive coloring layer and the high-temperature thermosensitive coloring layer were sequentially deposited on the substrate was prepared.

For the recording media fabricated according to Fabrication Examples 1 and 2 and Comparative Examples 1 to 3, colors were formed by any one selected from application of ultraviolet rays, heat transmission in the following T1 mode, heat transmission in the following T2 mode and heat transmission in the following T3 mode, all of which were performed to the recording media, and then the formed colors were observed. The observed result is represented by Table 1. The application of ultraviolet rays was performed using a high-pressure mercury lamp of 120 W at a distance of 15 cm from the recording medium for 5 minutes. The heat transmission was performed using a thermosensitive facsimile printing tester (TH-PMD, available from Okura Denki, Ltd.). The T1 mode was one of transmitting heat at a temperature of about 95° C. for a time of about 230 ms. The T2 mode was one of transmitting heat at a temperature of about 135° C. for a time of about 130 ms. And, the T3 mode was one of transmitting heat at a temperature of about 165° C. for a time of about 30 ms.

TABLE 1

| | | Appli- | | | | |
|---|---|---|---|---|---|---|
| | | cation | Heat | | | |
| | | of | transmission | | | |
| | structure of | ultraviolet | mode | | | |
| | layers | rays | T1 | T2 | T3 | Formed color |
| Fabrication | HTTCL(C) | x | x | — | x | M |
| Example 1 | | o | o | — | x | Y |
| | PDL(M) | o | x | — | o | C |
| | | x | o | — | x | R(M + Y) |
| | LTTCL(Y) | x | x | — | o | B(M + C) |
| | | o | o | — | o | G(Y + C) |
| | Substrate | x | o | — | o | BK(M + Y + C) |
| Fabrication | HTTCL(M) | x | x | — | x | C |
| Example 2 | | o | o | — | x | Y |
| | PDL(C) | o | x | — | o | M |
| | | x | o | — | x | G(C + Y) |
| | LTTCL(Y) | x | x | — | o | B(C + M) |
| | | o | o | — | o | R(Y + M) |
| | Substrate | x | o | — | o | BK(C + Y + M) |
| Comparative | LTTCL(Y) | x | x | — | x | M |
| Example 1 | | o | o | — | x | Y |
| | HTTCL(C) | o | x | — | o | G(C + Y) |
| | | x | o | — | x | R(M + Y) |
| | PDL(M) | x | x | — | o | BK(M + C + Y) |
| | | o | o | — | o | G(Y + C) |
| | Substrate | x | o | — | o | BK(M + Y + C) |
| Comparative | LTTCL(Y) | x | x | — | x | M |
| Example 2 | | o | o | — | x | Y |
| | PDL(M) | o | x | — | o | G(C + Y) |
| | | x | o | — | x | R(M + Y) |
| | HTTCL(C) | x | x | — | o | BK(M + C + Y) |
| | | o | o | — | o | G(Y + C) |
| | Substrate | x | o | — | o | BK(M + Y + C) |
| Comparative | HTTCL(M) | — | o | x | x | Y |
| Example 3 | | — | x | o | x | C(some mixed Y) |
| | MTTCL(C) | — | x | x | o | M(some mixed C) |
| | | — | o | o | o | G(Y + C) |
| | LTTCL(Y) | — | o | x | o | R(Y + M, |
| | | | | | | some mixed C) |
| | Substrate | — | x | o | o | B(C + M, |
| | | | | | | some mixed Y) |
| | | — | o | o | o | BK(Y + C + M) |

In Table 1, among the acronyms, HTTCL stands for high-temperature thermosensitive coloring layer, PDL for photosensitive decoloring layer, LTTCL for low-temperature thermosensitive coloring layer, and MTTCL for Intermediate (medium)-temperature thermosensitive layer. Further, among the symbols, C refers to cyan color, M refers to magenta color, Y refers to yellow color, R refers to red color, G refers to green color, B refers to blue color, and BK refers to black color. Furthermore, ‘x’ means that the particular temperature mode is used or the ultraviolet rays are applied.

Referring to Table 1, it can be found that, in the Fabrication Examples 1 and 2, where the low-temperature thermosensitive coloring layer, the photosensitive decoloring layer and the high-temperature thermosensitive coloring layer are sequentially deposited on the substrate, all the colors of C, M, Y, R, G, B and BK are clearly formed.

However, it can be found that, in Comparative Examples 1 and 2, where the high-temperature thermosensitive coloring layer is disposed on the substrate and the low-temperature thermosensitive coloring layer is disposed on the high-temperature thermosensitive coloring layer, the colors are not clearly formed and mixed with each other in the process of transmitting high heat for coloring the high-temperature thermosensitive coloring layer. This mixed color results because the low-temperature thermosensitive coloring layer forms undesired colors under the influence of the high heat. For this reason, a difference between when the thermosensitive coloring layers are successively deposited (Comparative 1) and when the photosensitive decoloring layer is interposed between the thermosensitive coloring layers is small.

Further, it can be found that, in Comparative Example 3, where the low-, intermediate- and high-temperature thermosensitive coloring layers are sequentially deposited on the substrate, thermal separation between these coloring layers is difficult, and thus, when an upper layer is colored, a lower layer is influenced to form undesired colors to some extent, so that the formed colors are not clear and mixed.

According to the embodiments of the present invention as mentioned above, it is possible to obtain a recording medium capable of realizing a full color image using a relatively simple recording device provided with a single thermal head having low- and high-temperature modes together and a single light source.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A multicolor recording medium, comprising:
a substrate having top and bottom surfaces;
a low-temperature thermosensitive coloring layer disposed on the top surface of the substrate;
a high-temperature thermosensitive coloring layer disposed on the low-temperature thermosensitive coloring layer; and
a photosensitive decoloring layer on the substrate.

2. The multicolor recording medium as set forth in claim 1, wherein the photosensitive decoloring layer is interposed between the low-temperature thermosensitive coloring layer and the high-temperature thermosensitive coloring layer.

3. The multicolor recording medium as set forth in claim 2, further comprising an intermediate layer interposed between at least one of the low-temperature thermosensitive coloring layer and the photosensitive decoloring layer, and the photosensitive decoloring layer and the high-temperature thermosensitive coloring layer.

4. The multicolor recording medium as set forth in claim 2, further comprising an undercoating layer interposed between the low-temperature thermosensitive coloring layer and the substrate.

5. The multicolor recording medium as set forth in claim 2, further comprising a passivation layer disposed on the high-temperature thermosensitive coloring layer.

6. The multicolor recording medium as set forth in claim 2, further comprising a backside coating layer disposed on the bottom surface of the substrate.

7. The multicolor recording medium as set forth in claim 1, wherein the photosensitive decoloring layer is disposed on the bottom surface of the substrate.

8. The multicolor recording medium as set forth in claim 7, further comprising an intermediate layer interposed between the low-temperature thermosensitive coloring layer and the high-temperature thermosensitive coloring layer.

9. The multicolor recording medium as set forth in claim 7, wherein the substrate is transparent.

10. The multicolor recording medium as set forth in claim 7, further comprising an opaque reflection layer disposed on the photosensitive decoloring layer.

11. The multicolor recording medium as set forth in claim 1, wherein the photosensitive decoloring layer contains at least one selected from the group consisting of a material having a structure transformed by light, a material having crystallinity changed by light, a material which can be self-coupled by light, and a material having a leaving group separated by light.

12. The multicolor recording medium as set forth in claim 1, wherein the photosensitive decoloring layer contains at least one selected from the group consisting of a mixture of a decolorant and a pigment, a mixture of a light-heat conversion agent and a thermalsensitive decolorant, and a mixture of a microcapsule containing the decolorant and the pigment.

13. The multicolor recording medium as set forth in claim 1, wherein the photosensitive decoloring layer contains at least one selected from the group consisting of an azo pigment, an azomethine pigment, a polymethine pigment, a quinone pigment, an indigo pigment, a diphenylmethane pigment, a tripethylmethane pigment, and a phthalocyanine pigment.

14. A multicolor recording device, comprising:
a light source to apply light to the recording medium of claim 1 to thus decolor a photosensitive decoloring layer; and
a thermal head having high- and low-temperature modes and transmitting heat to the recording medium to color thermosensitive coloring layers of the recording medium.

15. The multicolor recording device as set forth in claim 14, wherein the thermal head operates in the high-temperature mode for a short time and in the low-temperature mode for a long time.

16. The multicolor recording device as set forth in claim 14, wherein the photosensitive decoloring layer is interposed between low- and high-temperature thermosensitive coloring layers of the thermosensitive coloring layers.

17. The multicolor recording device as set forth in claim 14, wherein the photosensitive decoloring layer is disposed on a bottom surface of a substrate, and
wherein the recording medium further comprises an intermediate layer interposed between the low- and high-temperature thermosensitive coloring layers of the thermosensitive coloring layers.

18. A recording method comprising:
feeding the recording medium of claim 1;
applying light to the recording medium to thus decolor a photosensitive decoloring layer; and
transmitting high and low heat to the recording medium having the decolored photosensitive decoloring layer to thus color thermosensitive coloring layers.

19. The multicolor recording method as set forth in claim 18, wherein the high heat is transmitted for a short time and the low heat is transmitted for a long time.

20. The multicolor recording method as set forth in claim 18, further comprising coloring the thermosensitive coloring layers, comprising:
transmitting the high heat to the recording medium to color a high-temperature thermosensitive coloring layer of the thermosensitive coloring layers, and
transmitting the low heat to the recording medium to color a low-temperature thermosensitive coloring layer of the thermosensitive coloring layers.

21. The multicolor recording method as set forth in claim 18, wherein the photosensitive decoloring layer is interposed between low- and high-temperature thermosensitive coloring layers of the thermosensitive coloring layers.

22. The multicolor recording method as set forth in claim 18, wherein the photosensitive decoloring layer is disposed on a bottom surface of a substrate, and
the recording medium further comprises an intermediate layer interposed between low- and high-temperature thermosensitive coloring layers of the thermosensitive coloring layers.
